(19) United States
(12) Patent Application Publication
(10) Pub. No.: US 2026/0221824 A1
(43) Pub. Date: Jul. 30, 2026

(54) ELECTRIC ROTATING MACHINE AND ELECTRIC-ROTATING-MACHINE MANUFACTURING METHOD

(71) Applicant: Mitsubishi Electric Mobility Corporation, Tokyo (JP)

(72) Inventors: Takaaki NAGASHIMA, Tokyo (JP); Shinsuke KAYANO, Tokyo (JP); Takeshi KUBOTA, Tokyo (JP)

(73) Assignee: Mitsubishi Electric Mobility Corporation, Tokyo (JP)

(21) Appl. No.: 19/152,220

(22) PCT Filed: Jul. 24, 2023
(86) PCT No.: PCT/JP2023/027033

§ 371 Date: Jul. 30, 2025

(51) Int. Cl. H02K 1/276; H02K 15/40

(52) U.S. Cl. CPC H02K 1/276; H02K 15/40; H02K 2213/03; H02K 2215/00

(57) ABSTRACT

The rotor core of a rotating electric machine having a plurality of magnet insertion holes has a hole portion between a fixing hole and the outmost-circumference peripheral portion of the magnet insertion holes, and the hole portion is composed of a positioning function portion and a weight-saving function portion.

### TECHNICAL FIELD

The present disclosure relates to an electric rotating machine and an electric-rotating-machine manufacturing method.

### BACKGROUND ART

To date, there has been known an electric rotating machine provided with a stator having a ring-shaped stator core and a stator coil mounted on the stator core and a rotor having a rotor core inserted into an inner space of the stator core and two or more permanent magnets that are embedded in the rotor core and form magnetic-field poles. In general, in an electric rotating machine configured in such a manner, the stator core has two or more teeth that protrude radially inward and are arranged spaced apart by a constant distance from one another in the circumferential direction; the rotor core has two or more magnet insertion holes into which respective permanent magnets for forming magnetic-field poles close to the outer circumferential portion are inserted and bridge portions for sectioning the magnet insertion holes.

To date, among electric rotating machines configured as described above, there has been disclosed an electric rotating machine in which holes, which make it possible to insert a jig for positioning the position of the rotor core with respect to the stator core at a time of machining or assembling the rotor core, are formed in the rotor core (for example, refer to Patent Document 1).

In addition, there has been disclosed an electric rotating machine in which in order to restrict the flow of magnetic flux, polygonal aperture holes as flux barriers are formed in the rotor core (for example, refer to Patent Document 2). Moreover, there has been disclosed an electric rotating machine in which hollow portions, through which a refrigerant flows, are formed in the rotor core (for example, refer to Patent Document 3). Each of the rotor-core aperture portion disclosed in Patent Document 2 and the rotor-core hollow portion disclosed in Patent Document 3 has also a function for saving the weight of the rotor.

### PRIOR ART REFERENCE

### Patent Document

[Patent Document 1] Japanese Patent Application Laid-Open No. 2000-4550
[Patent Document 2] Japanese Patent Application Laid-Open No. 2019-165592
[Patent Document 3] Japanese Patent Application Laid-Open No. 2005-184957

### DISCLOSURE OF THE INVENTION

### Problems to be Solved by the Invention

The foregoing conventional electric rotating machine has, as its constituent components, a rotor core in which a great number of electromagnetic steel plates are stacked, two or more permanent magnets inserted into two or more respective magnet insertion holes formed in the rotor core, and a rotor shaft whose axial-direction length is larger than that of the rotor core; although the rotor shaft is pivotably supported by a bearing, the weight of the rotor is large because it is configured as described above; therefore, the mechanical loss in the bearing that supports the rotor shaft becomes large, so that the efficiency of the electric rotating machine is deteriorated. Thus, the efficiency of the electric rotating machine is deteriorated in proportion to the weight of the rotor.

It is effective to form a hole in the rotor core so as to decrease the weight of the rotor core. However, depending on the position of the hole in the rotor core, the flow of magnetic flux in the rotor core is hindered by the hole, hence the iron loss may increase, or the strength of the rotor to the stress caused by centrifugal force or to the stress caused by fitting between the rotor shaft and the rotor core may become insufficient. Accordingly, the area in which the hole can be formed is limited.

The conventional electric rotating machine disclosed in Patent Document 1 is provided with a positioning hole in the rotor core; in the case where in addition to the positioning hole, a hole for decreasing the weight of the rotor is provided, it is required to provide the both holes in the limited area of the rotor core, in consideration of prevention of increase in the rotor iron loss and prevention of decrease in the rotor strength. However, when it is tried to form the hole for decreasing the weight and the positioning hole separately in the foregoing limited area, a bridge portion that sections the two holes is formed and the stress converges on the bridge portion, which causes the strength of the rotor core to decrease.

Moreover, although the conventional electric rotating machine disclosed in Patent Document 2 is provided with a polygonal aperture hole as a flux barrier, and the conventional electric rotating machine disclosed in Patent Document 3 is provided with a hollow portion through which a refrigerant flows, none of the conventional electric rotating machines has a positioning hole in the rotor core; furthermore, none of the foregoing aperture hole and the hollow portion is provided in the rotor-core area for which the prevention of increase in the rotor iron loss and the prevention of decrease in the rotor strength are considered.

The present disclosure is to disclose a technology for solving the foregoing problems; the objective thereof is to provide an electric rotating machine that makes it possible to decrease the cost at a time of manufacturing thereof and to raise the efficiency thereof.

Moreover, the objective of the present disclosure is to provide an electric-rotating-machine manufacturing method of manufacturing the electric rotating machine that makes it possible to decrease the cost at a time of manufacturing thereof and to raise the efficiency thereof.

### Means for Solving the Problems

An electric rotating machine according to the present disclosure is provided with
a stator core formed in a ring-shaped manner,
a stator coil mounted on the stator core,
a rotor core whose outer circumferential portion faces an inner circumference portion of the stator core through an air gap and that has two or more magnet insertion holes,
two or more permanent magnets that are inserted into the respective two or more magnet insertion holes and form two or more magnetic-field poles in the rotor core,
a rotor shaft that penetrates a fixing hole provided in a radial-direction central portion of the rotor core and supports the rotor core, and
bearings that pivotably support the rotor shaft.

The electric rotating machine is characterized
in that the rotor core has a hole portion formed between the fixing hole and an outmost-circumference peripheral portion of the magnet insertion hole, and
in that the hole portion includes
   a positioning function portion that contributes to positioning of the rotor core and
   a weight-saving function portion that contributes to weight-saving of the rotor core.

Moreover, an electric-rotating-machine manufacturing method according to the present disclosure is a manufacturing method of manufacturing the foregoing electric rotating machine.

The electric-rotating-machine manufacturing method is characterized by including
a stator-core holding process of holding the stator core by a stator-core holding portion of a center-axis positioning jig,
a rotor-core positioning process of positioning the rotor with respect to the stator, by inserting two or more rod-shaped positioning members in a rotor-core positioning portion of the center-axis positioning jig into respective positioning function portions of the hole portions in the rotor core, and
an assembling process of assembling at least part of the electric rotating machine after positioning of the rotor core with respect to the stator core has been performed in the rotor-core positioning process.

Moreover, an electric-rotating-machine manufacturing method according to the present disclosure is a manufacturing method of manufacturing an electric rotating machine in which at least one of axial-direction end portions of the rotor core is provided with an end plate that abuts on the rotor core in the axial direction, and the end plate is provided with a hole portion having a positioning function portion that coincides with at least the positioning function portion in the hole portion formed in the rotor core.

The electric-rotating-machine manufacturing method is characterized by including
a stator-core holding process of holding the stator core by a stator-core holding portion of a center-axis positioning jig,
a rotor-core positioning process of positioning the rotor core with respect to the stator core, by inserting two or more rod-shaped positioning members in a rotor-core positioning portion of the center-axis positioning jig into the respective positioning function portions of the hole portions provided in the end plate and the respective positioning function portions of the hole portions provided in the rotor core, and
an assembling process of assembling at least part of the electric rotating machine after positioning of the rotor core with respect to the stator core has been performed in the rotor-core positioning process.

Furthermore, an electric-rotating-machine manufacturing method according to the present disclosure is a manufacturing method of manufacturing an electric rotating machine in which at least one of axial-direction end portions of the rotor core is provided with an end plate that abuts on the rotor core in the axial direction, and the end plate is provided with a hole portion having a positioning function portion that coincides with at least the positioning function portion in the hole portion formed in the rotor core.

The electric-rotating-machine manufacturing method is characterized in that by inserting two or more rod-shaped positioning portions provided in a jig into both the respective positioning function portions of the hole portions provided in the end plate and the respective positioning function portions of the hole portions provided in the rotor core, positioning between the end plate and the rotor core is performed.

Moreover, an electric-rotating-machine manufacturing method according to the present disclosure is a manufacturing method of manufacturing an electric rotating machine
in which at least one of axial-direction end portions of the rotor core is provided with an end plate that abuts on the rotor core in the axial direction,
in which the end plate has two or more rod-shaped positioning members that each extend in the axial direction of the rotor core, and
in which the two or more positioning members are inserted into at least the respective positioning function portions in the two-or-more hole portions formed in the rotor core.

The electric-rotating-machine manufacturing method is characterized in that by inserting the two or more rod-shaped positioning members provided in the end plate into the respective positioning function portions of the hole portions provided in the rotor core, positioning between the end plate and the rotor core is performed.

### Advantage of the Invention

The present disclosure makes it possible to obtain an electric rotating machine that can decrease the cost at a time of manufacturing thereof and can raise the efficiency thereof.

Moreover, the electric-rotating-machine manufacturing method according to the present disclosure makes it possible to obtain an electric rotating machine that can decrease the cost at a time of manufacturing thereof and can raise the efficiency thereof.

### BRIEF DESCRIPTION OF THE DRAWINGS

FIG. 1 is a longitudinal cross-sectional view symbolically illustrating an electric rotating machine according to Embodiment 1;

FIG. 2 is a cross-sectional view of the rotor of the electric rotating machine according to Embodiment 1;

FIG. 3 is an explanatory view for the rotor of the electric rotating machine according to Embodiment 1;

FIG. 4 is an explanatory view for the rotor of an electric rotating machine according to Embodiment 2;

FIG. 5 is an explanatory view for the rotor of an electric rotating machine according to Embodiment 3;

FIG. 6 is an explanatory view for the rotor of an electric rotating machine according to Embodiment 4;

FIG. 7 is an explanatory view for the rotor of an electric rotating machine according to Embodiment 5;

FIG. 8 is an explanatory view for the rotor of an electric rotating machine according to Embodiment 6; and

FIG. 9 is an explanatory view for the rotor of an electric rotating machine according to Embodiment 7.

### MODE FOR CARRYING OUT THE INVENTION

The electric rotating machine according to each of after-mentioned Embodiments of the present disclosure is a permanent magnet synchronous motor.

### Embodiment 1

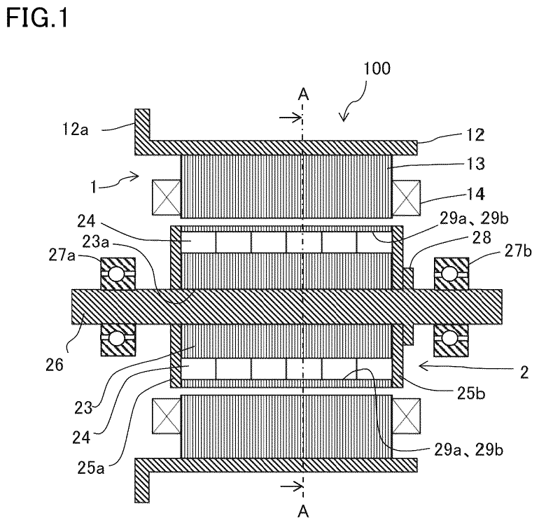

FIG. 1 is a longitudinal cross-sectional view symbolically illustrating an electric rotating machine according to Embodiment 1. In FIG. 1, an electric rotating machine 100 has a stator 1 and a rotor 2. The stator 1 has a cylindrical tubular metal frame 12, a ring-shaped stator core 13 fitted to the inner circumference portion of the frame 12, and a stator coil 14 mounted on the stator core 13. The stator coil 14 is formed of, for example, a Y-connected three-phase coil.

At its one axial-direction end portion, the frame 12 has a flange 12a for fixing the electric rotating machine 100 to, for example, another member (unillustrated) of a vehicle. The stator core 13 includes a great number of ring-shaped electromagnetic steel plates that are stacked in the axial direction and has a two or more teeth (unillustrated) protruding toward the inner circumference thereof and two or more slots (unillustrated) that are each formed between adjacent teeth. The stator coil 14 is inserted into the slot.

The rotor 2 is inserted into the inner space of the stator core 13 and is provided with a rotor core 23 whose outer circumferential portion faces the inner circumference portion of the stator core 13 through an air gap, two or more permanent magnets 24 embedded in the portion close to the outer circumferential portion of the rotor core 23, a first end plate 25a that abuts on one axial-direction end portion of the rotor core 23, a second end plate 25b that abuts on the other axial-direction end portion of the rotor core 23, and a rotor shaft 26 penetrating a fixing hole 23a provided in the radial-direction central portion of the rotor core 23, the first end plate 25a, and the second end plate 25b. The rotor core 23 includes a great number of ring-shaped electromagnetic steel plates that are stacked in the axial direction thereof.

Both respective axial-direction end portions of the rotor shaft 26 are pivotably supported by a first bearing 27a and a second bearing 27b provided respectively in a pair of brackets (unillustrated) fixed to the frame 12. The axial-direction position of the rotor core 23 with respect to the rotor shaft 26 is restricted because the second end plate 25b abuts on the stopper 28 provided on the rotor shaft 26.

The rotor core 23 is provided with eight first magnet insertion holes 29a and eight second magnet insertion holes 29b facing the respective corresponding first magnet insertion holes 29a. The foregoing permanent magnets 24 are inserted into the respective corresponding first magnet insertion holes 29a and eight second magnet insertion holes 29b. The permanent magnet 24 extends from the one axial-direction end portion of the rotor core 23 to the other axial-direction end portion thereof and is divided into six portions, for example, in the axial direction of the rotor core 23.

The first end plate 25a and the second end plate 25b abut on the one axial-direction end portion and the other axial-direction end portion, respectively, of the rotor core 23, and prevent the permanent magnets 24 from falling or protruding from the respective first magnet insertion holes 29a or second magnet insertion holes 29b. In addition, a hole for adjusting the rotation balance of the rotor 2 or a plate as a balance weight may be added to at least one of the first end plate 25a and the second end plate 25b.

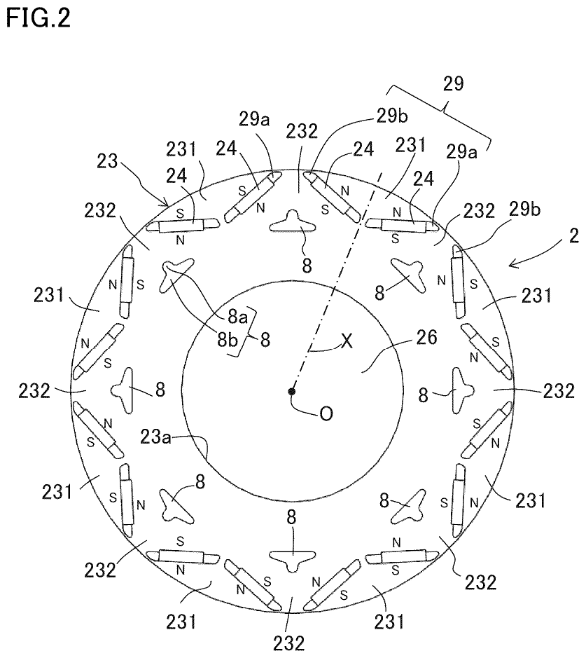

Next, the configuration of the rotor core 23 will be explained. FIG. 2 is a cross-sectional view of the rotor of the rotating electric machine according to Embodiment 1, when the cross section of the rotor along the A-A line in FIG. 1 is viewed from the direction of the arrow. In FIG. 2, the rotor core 23 is supported by the rotor shaft 26 penetrating the fixing hole 23a provided in the central portion thereof.

The rotor shaft 26, in which the rotor core 23, the first end plate 25a (refer to FIG. 1), and the second end plate 25b (refer to FIG. 1) are integrally fixed, transfers the torque of the rotor core 23 to the outside of the electric rotating machine 100. In Embodiment 1, the rotor shaft 26 is formed of a solid shaft. In addition, in Embodiment 1, the rotor core 23, the first end plate 25a, and the second end plate 25b are fitted to the rotor shaft 26 through a press-fitting process or a shrink-fitting process.

In addition, the rotor shaft 26 and the rotor core 23 may be fitted to each other through a key mechanism provided between the peripheral portion of the fixing hole 23a in the rotor core 23 and the outer circumference portion of the rotor shaft 26. In addition, the rotor shaft 26 may have a boss structure in the shape of a hollow cylindrical tube.

As described above, the rotor core 23 is formed of a great number of electromagnetic steel plates stacked in the axial direction; eight magnet insertion hole pairs 29, each of which includes the first magnet insertion hole 29a and the second magnet insertion hole 29b disposed symmetrically with respect to a virtual-straight-line X that intersects the center axis O of the rotor core 23, are arranged spaced by 45 degrees apart from one another around the center axis O. In addition, the virtual-straight-line X coincides with an after-mentioned d axis d-axis.

In each of the eight magnet insertion hole pairs 29, the first magnet insertion hole 29a and the second magnet insertion hole 29b are arranged in a V-shaped manner where the facing distance with which they face each other at the radially outside of the rotor core 23 is larger than the facing distance with which they face each other at the radially inside of the rotor core 23. In each of the eight magnet insertion hole pairs 29, the respective permanent magnets 24 whose cross sections are each rectangularly formed are inserted into the first magnet insertion hole 29a and the second magnet insertion hole 29b. Each of the permanent magnets 24 is formed of, for example, a Neodymium rare-earth magnet.

As illustrated in FIG. 2, in each of the magnet insertion hole pairs 29, the permanent magnet 24 inserted into the first magnet insertion hole 29a and the permanent magnet 24 inserted into the second magnet insertion hole 29b are magnetized in such a way that the opposing long side portions thereof have the same polarity. The two permanent magnets 24 and a first portion 231 of the rotor core 23, sandwiched between the two permanent magnets 24, configure one magnetic-field pole. The total number of the magnetic-field poles is eight. The electric rotating machine 100 according to Embodiment 1 is an 8-pole IPM motor in which totally 16 permanent magnets 24 are arranged.

A hole portion 8 is provided in a second portion 232 of the rotor core 23, sandwiched between the two adjacent magnetic-field poles. The hole portion 8 includes a positioning function portion 8a for positioning the rotor core 23 and a weight-saving function portion 8b for decreasing the weight of the rotor core 23.

A jig is inserted into the positioning function portion 8a when the electric rotating machine 100 is machined or assembled, so that with respect to the stator core 13, the radial-direction positioning and the circumferential-direction positioning of the rotor core 23 are performed. In addition, in some cases, the positioning function portion 8a is utilized also in positioning of the first end plate 25a and the second end plate 25b.

In addition, as described later, it may be allowed that a rod-shaped positioning member provided in at least one of the first end plate 25a and the second end plate 25b is inserted into the positioning function portion 8a of the hole portion 8 in the rotor core 23 so as to position the rotor core 23.

In general, in order to position the rotor core 23, it is required to provide at least two positioning holes in the rotor core 23. In the case where the rotor-shaft-insertion fixing hole 23a in the rotor core 23 is utilized as one of the positioning holes for the rotor core 23, it is only necessary to provide another positioning hole in addition to the fixing hole 23a. However, providing another positioning hole in addition to the fixing hole 23a may pose a problem to the rotation balance of the rotor 2.

Thus, it is desirable that in view of adjustment of the rotation balance of the rotor 2 and weight saving, two-or-more hole portions 8 each having the positioning function portion 8a are provided and these hole portions 8 are arranged spaced evenly apart from one another in the circumferential direction of the rotor core 23. In the electric rotating machine 100 according to Embodiment 1, totally eight of hole portions 8 each including the positioning function portion 8a and the weight-saving function portion 8b are formed in the respective second portions 232 of the rotor core, each sandwiched between the two adjacent magnetic-field poles.

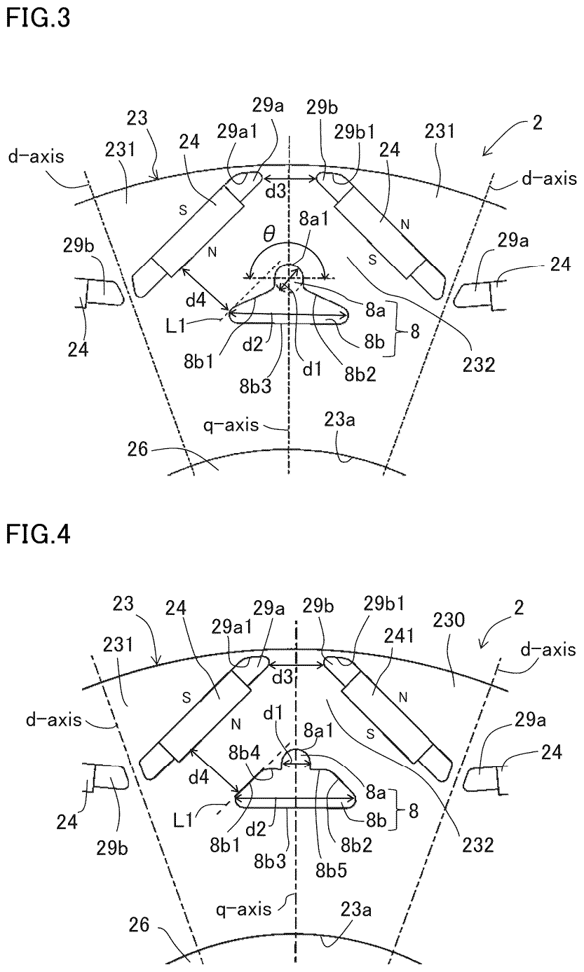

FIG. 3 is an explanatory view for the rotor of the electric rotating machine according to Embodiment 1. In FIG. 3, the radial-direction center of the hole portion 8 including the positioning function portion 8a and the weight-saving function portion 8b is provided in such a way as to coincide with a q axis q-axis forming an electric angle of 90 [°] with respect to the d axis d-axis of the rotor core. This configuration makes it possible that the hole portion 8 is provided substantially in the middle portion of the two adjacent magnetic-field pole and that an imbalance in the magnetic flux flow between the two adjacent magnetic-field poles is prevented.

In addition, the hole portion 8 is provided in the area of the rotor core 23 among the peripheral portion of the fixing hole 23a, an outmost-circumference peripheral portion 29a1 located at the outmost circumference side of the first magnet insertion hole 29a, and an outmost-circumference peripheral portion 29b1 located at the outmost circumference side of the second magnet insertion hole 29b. The positioning function portion 8a of the hole portion 8 has a peripheral portion 8a1 that coincides with a part of the arc of a virtual circle that has its center on q axis q-axis and a diameter of d1 [mm].

In addition, in Embodiment 1, the weight-saving function portion 8b of the hole portion 8 has a pair of side peripheral portions 8b1 and 8b2 that extend obliquely and symmetrically from respective both end portions of the peripheral portion 8a1 of the positioning function portion 8a to respective corresponding both sides of the q axis q-axis and an inner-circumference peripheral portion 8b3 connected with the pair of side peripheral portions 8b1 and 8b2. The inner-circumference peripheral portion 8b3 of the weight-saving function portion 8b is formed in a linear shape and perpendicular to the q axis q-axis.

The peripheral portion 8a1 of the positioning function portion 8a is provided in such a way as to be apart toward the q axis q-axis from a virtual straight line L1 that is parallel with the long side of the permanent magnet 24 inserted into the first magnet insertion hole 29a and is superimposed on the side peripheral portion 8b1 of the weight-saving function portion 8b; furthermore, the peripheral portion 8a1 of the positioning function portion 8a is provided in such a way as to be apart toward the q axis q-axis from a virtual straight line (unillustrated) that is parallel with the long side of the permanent magnet 24 inserted into the second magnet insertion hole 29b and is superimposed on the side peripheral portion 8b2 of the weight-saving function portion 8b. In other words, the peripheral portion 8a1 of the positioning function portion 8a makes contact with none of the two virtual straight lines.

The purpose of providing the positioning hole in the rotor core 23 is to perform positioning of the rotor core 23 with respect to the stator core 13, by making a positioning jig penetrate the foregoing positioning hole. Thus, in Embodiment 1, because the area, of the hole portion 8, that is penetrated by the jig is the positioning function portion 8a, the positioning function portion 8a substantially corresponds to a hole that contributes to positioning of the rotor core 23. In the hole portion 8, the area other than the positioning function portion 8a is the weight-saving function portion 8b that contributes to decreasing the weight of the rotor core 23.

The shape and size of the positioning function portion 8a are formed in such a way as to match the shape and size of a rod-shaped positioning portion of the jig to be utilized in the positioning process for the rotor core 23. Moreover, because the weight-saving function portion 8b is provided for the purpose of decreasing the weight of the rotor core 23, the occupation area of the weight-saving function portion 8b is set to be larger than the occupation area of the positioning function portion 8a. That is to say, letting S1 denote the occupation area of the positioning function portion 8a and letting S2 denote the occupation area of the weight-saving function portion 8b, the positioning function portion 8a and the weight-saving function portion 8b are formed in such a way that S2>S1 is established.

The second portion 232 of the rotor core 23, sandwiched between the first magnet insertion hole 29a and the second magnet insertion hole 29b, continuously becomes narrower from the inner circumferential side toward the outer circumferential side of the rotor core 23. Accordingly, in Embodiment, the positioning function portion 8a is disposed at the outer circumferential side of the rotor core 23, and the weight-saving function portion 8b is disposed at the inner circumferential side of the rotor core 23. As a result, the occupation area S2 of the weight-saving function portion 8b can readily be formed to be larger than the occupation area S1 of the positioning function portion 8a.

Moreover, the circumferential-direction maximum width d2 [mm] of the weight-saving function portion 8b is formed to be larger than the circumferential-direction maximum width d1 [mm] of the positioning function portion 8a (i.e., the diameter d1 [mm] of the virtual circle) (d2>d1). By forming in this manner, the effect on the flux flowing through the rotor core 23 can be reduced. Still moreover, because the weight of the rotor core is reduced by the hole portion 8 including the positioning function portion 8a and the weight-saving function portion 8b, the mechanical loss in the first bearing 27a and the second bearing 27b that pivotably support the rotor shaft 26 is reduced, so that the efficiency of the rotor 2 is raised.

In Embodiment 1, although the respective areas of the positioning function portion 8a and the weight-saving function portion 8b are separated from each other, the hole portion 8 has an outline shape integrating the respective shapes thereof; furthermore, the positioning function portion 8a and the weight-saving function portion 8b are in the shape which the respective shapes thereof are connected through smooth-curves. This configuration makes it possible to relax stress concentration in the rotor core 23.

Moreover, in Embodiment 1, it is assumed that as a jig for positioning the rotor core 23, a cylindrical columnar rod-shaped jig is utilized. Accordingly, in the case where the angle range θ of the arc-shaped peripheral portion 8a1 of the positioning function portion 8a is set to a mechanical angle of 180 [°] or larger, the area occupied by an virtual circle, indicated by a broken line that supplements the peripheral portion 8a1 so as to obtain a complete arc shape, corresponds to the positioning function portion 8a, and the area obtained by removing the positioning function portion 8a from the hole portion 8 corresponds to the weight-saving function portion 8b.

In addition, in Embodiment 1, it is assumed that as described above, as a jig to be utilized in a rotor-core-positioning process, a cylindrical columnar rod-shaped jig is utilized, the peripheral portion 8a1 of the positioning function portion 8a is made to be in the shape of an arc corresponding to the circular cross-sectional shape of the cylindrical columnar jig, and the angle range θ of the arc-shaped peripheral portion 8a1 of the positioning function portion 8a is set to a mechanical angle of 180 [°] or larger so that the shape of the peripheral portion 8a1 matches the outline shape of the majority of the jig; however, the shape of the peripheral portion 8a1 of the positioning function portion 8a is not limited to being such arc-shaped but can be an optimum shape corresponding to the cross-sectional shape of the positioning jig. For example, in the case where a positioning jig having an elliptical or rectangular cross-sectional shape is utilized, it is made possible that at least part of the shape of the peripheral portion 8a1 of the positioning function portion 8a is made to be a shape that matches the outline shape of the ellipse or the rectangle.

In order to decrease the weight of the rotor core 23, the occupation area S2 of the weight-saving function portion 8b is set to be relatively large; therefore, when the whole weight-saving function portion 8b is disposed in the area between the adjacent magnet insertion holes, the flow of magnetic flux in the rotor core 23 is hindered, hence disadvantage is provided to the performance of the electric rotating machine. In contrast, when the weight-saving function portion 8b is disposed at the inner radial side close to the fixing hole 23a of the rotor core 23, the strength of the rotor core 23 is deteriorated. Thus, with regard to the weight-saving function portion 8b, it is desirable that its occupation area in the area between the adjacent magnet insertion holes is reduced as far as possible and that it is provided in an area apart as far as possible from the fixing hole 23a of the rotor core 23.

In the first portion 231 of the rotor core 23, forming a magnetic-field pole, the d axis d-axis is the center axis between the two respective opposing permanent magnets 24 that are inserted into the first magnet insertion hole 29a and the second magnet insertion hole 29b; the q axis q-axis is the center axis between the d axis d-axis and adjacent another d axis d-axis. The q axis q-axis coincides with the center axis of the second portion 232 of the rotor core 23, sandwiched between a pair of the adjacent two magnet insertion holes 29.

The center of the hole portion 8 is disposed on the q axis q-axis. This configuration makes it possible that the hole portion 8 is provided substantially in the middle portion of the two adjacent magnetic-field poles and that an imbalance in the magnetic flux flow between the two adjacent magnetic-field poles is prevented.

In view of the rotation balance of the rotor 2, it is desirable that the hole portion 8 is disposed symmetrically with respect to the q axis q-axis. When letting d3 [mm] denote a shortest inter-magnetic-field-pole distance, which is a distance from the first magnet insertion hole 29a of one magnetic field pole to the second magnet insertion hole 29b of the adjacent magnetic field pole, an area—its width with which the magnetic flux passes is smaller than the shortest inter-magnetic-field-pole distance d3 [mm]—exists in the rotor core 23, the magnetic loss in the rotor core 23 increases.

Therefore, as described above, the shortest distance d4 [mm] between the magnet insertion hole and the hole portion, more specifically, each of the shortest distance d4 [mm] between the first magnet insertion hole 29a and the hole portion 8 and the shortest distance d4 [mm] (unillustrated) between the second magnet insertion hole 29b and the hole portion 8 is set to be the same as or larger than the shortest inter-magnetic-field-pole distance d3 [mm] (d4≥d3). This configuration makes it possible that the effect on the magnetic flux flowing through the rotor core 23 is reduced and that the efficiency of the rotor 2 is prevented from being deteriorated.

In addition, it is only necessary that the shortest distance d4 [mm] between the magnet insertion hole and the hole portion 8 and the shortest inter-magnetic-field-pole distance d3 [mm] are made to be one and the same, so that the weight-saving effect is raised while the magnetic loss is suppressed. The stress due to fitting between the rotor core 23 and the rotor shaft 26 and the stress due to the centrifugal force based on rotation of the rotor 2 are caused at the inner-circumference peripheral portion 8b3 of the weight-saving function portion 8b. Thus, it is desirable that the stress due to fitting between the rotor core 23 and the rotor shaft 26 and the stress due to the centrifugal force based on rotation of the rotor 2 are preliminarily calculated and then the optimum distance between the peripheral portion of the fixing hole 23a in the rotor core 23 and the inner-circumference peripheral portion 8b3 of the weight-saving function portion 8b is determined based on the calculation result. The foregoing optimum-distance setting makes it possible to suppress the effect of the stress on the inner-circumference peripheral portion 8b3 of the weight-saving function portion 8b.

In the electric rotating machine according to Embodiment 1, the mechanical loss in the bearing portions is reduced by the hole portion whose effect on the magnetic flux is small and that has a positioning function and a weight-saving function, so that the efficiency of the rotor can be raised.

### Embodiment 2

Next, with regard to an electric rotating machine according to Embodiment 2, the configuration of a hole portion will mainly be explained. FIG. 4 is an explanatory view for the rotor of the electric rotating machine according to Embodiment 2. In FIG. 4, as is the case with Embodiment 1, a hole portion 8 including a positioning function portion 8a and a weight-saving function portion 8b is provided in such a way that the center line thereof coincides with a q axis q-axis. This configuration makes it possible that the hole portion 8 is provided substantially in the middle portion of the two adjacent magnetic-field poles and that an imbalance in the magnetic flux flow between the two adjacent magnetic-field poles is prevented.

The shortest distance d4 [mm] between the magnet insertion hole and the hole portion, more specifically, each of the shortest distance d4 [mm] between the first magnet insertion hole 29a and the hole portion 8 and the shortest distance d4 [mm] (unillustrated) between the second magnet insertion hole 29b and the hole portion 8 is formed to be the same as or larger than the shortest inter-magnetic-field-pole distance d3 [mm] (d4≥d3).

The peripheral portion 8a1 of the positioning function portion 8a is provided in such a way as to be apart toward the q axis q-axis from a virtual straight line L1 that is parallel with the long side of the permanent magnet 24 inserted into the first magnet insertion hole 29a and is superimposed on one side peripheral portion 8b1 of the weight-saving function portion 8b. Furthermore, the peripheral portion 8a1 of the positioning function portion 8a is provided in such a way as to be apart toward the q axis q-axis from a virtual straight line (unillustrated) that is parallel with the long side of the permanent magnet 24 inserted into the second magnet insertion hole 29b and is superimposed on the other side peripheral portion 8b2 of the weight-saving function portion 8b.

The one side peripheral portion 8b1 of the weight-saving function portion 8b is connected with one end portion of the peripheral portion 8a1 of the positioning function portion 8a through the intermediary of one outer-circumference peripheral portion 8b4 that is parallel to the inner-circumference peripheral portion 8b3; the other side peripheral portion 8b2 of the weight-saving function portion 8b is connected with the other end portion of the peripheral portion 8a1 of the positioning function portion 8a through the intermediary of the other outer-circumference peripheral portion 8b5 that is parallel to the inner-circumference peripheral portion 8b3.

The one side peripheral portion 8b1 of the weight-saving function portion 8b1 is superimposed on the virtual straight line L1 that is parallel to the long side of the permanent magnet 24 inserted into the first magnet insertion hole 29a; furthermore, the other side peripheral portion 8b2 of the weight-saving function portion 8b is superimposed on the virtual straight line (unillustrated) that is parallel to the long side of the permanent magnet 24 inserted into the second magnet insertion hole 29b. This configuration makes it possible to enlarge the occupation area of the hole portion 8, while suppressing the magnetic loss in the rotor 2.

The other configurations of the electric rotating machine according to Embodiment 2 is the same as those of the electric rotating machine according to Embodiment 1.

In the electric rotating machine according to Embodiment 2, the mechanical loss in the bearing portions is reduced by the hole portion whose effect on the magnetic flux is small and that has a positioning function and a weight-saving function, so that the efficiency of the rotor can be raised.

### Embodiment 3

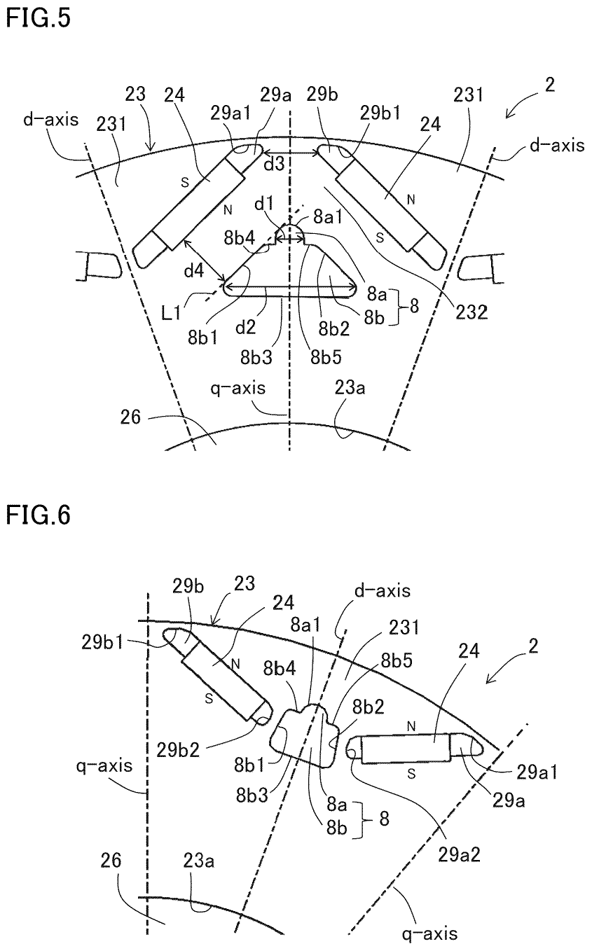

Next, with regard to an electric rotating machine according to Embodiment 3, the configuration of a hole portion will mainly be explained. FIG. 5 is an explanatory view for the rotor of the electric rotating machine according to Embodiment 3. In FIG. 5, as is the case with Embodiment 1, a hole portion 8 including a positioning function portion 8a and a weight-saving function portion 8b is provided in such a way that the center line thereof coincides with a q axis q-axis. This configuration makes it possible that the hole portion 8 is provided substantially in the middle portion of the two adjacent magnetic-field poles and that an imbalance in the magnetic flux flow between the two adjacent magnetic-field poles is prevented.

The shortest distance d4 [mm] between the magnet insertion hole and the hole portion, that is to say, each of the shortest distance d4 [mm] between the first magnet insertion hole 29a and the hole portion 8 and the shortest distance d4 [mm] (unillustrated) between the second magnet insertion hole 29b and the hole portion 8 is configured to be the same as or larger than the shortest inter-magnetic-field-pole distance d3 [mm] (d4≥d3).

The peripheral portion 8a1 of the positioning function portion 8a makes contact with a virtual straight line L1 that is parallel with the long side of the permanent magnet 24 inserted into the first magnet insertion hole 29a and is superimposed on one side peripheral portion 8b1 of the weight-saving function portion 8b. Moreover, the peripheral portion 8a1 of the positioning function portion 8a makes contact with a virtual straight line (unillustrated) that is parallel with the long side of the permanent magnet 24 inserted into the second magnet insertion hole 29b and is superimposed on the other side peripheral portion 8b2 of the weight-saving function portion 8b.

The one side peripheral portion 8b1 of the weight-saving function portion 8b is connected with one end portion of the peripheral portion 8a1 of the positioning function portion 8a through the intermediary of one outer-circumference peripheral portion 8b4 that is parallel to the inner-circumference peripheral portion 8b3; the other side peripheral portion 8b2 of the weight-saving function portion 8b is connected with the other end portion of the peripheral portion 8a1 of the positioning function portion 8a through the intermediary of the other outer-circumference peripheral portion 8b5 that is parallel to the inner-circumference peripheral portion 8b3.

The one side peripheral portion 8b1 of the weight-saving function portion 8b is superimposed on the virtual straight line L1, and the other side peripheral portion 8b2 of the weight-saving function portion 8b is superimposed on the virtual straight line that is parallel to the long side of the permanent magnet 24 inserted into the second magnet insertion hole 29b. This configuration makes it possible to enlarge the occupation area of the hole portion 8, while suppressing the magnetic loss in the rotor 2.

The other configurations of the electric rotating machine according to Embodiment 3 is the same as those of the electric rotating machine according to Embodiment 1.

In the electric rotating machine according to Embodiment 3, the mechanical loss in the bearing portions is reduced by the hole portion whose effect on the magnetic flux is small and that has a positioning function and a weight-saving function, so that the efficiency of the rotor can be raised.

### Embodiment 4

Next, with regard to an electric rotating machine according to Embodiment 4, the configuration of a hole portion will mainly be explained. FIG. 6 is an explanatory view for the rotor of the electric rotating machine according to Embodiment 4. In FIG. 6, a hole portion 8 including a positioning function portion 8a and a weight-saving function portion 8b is disposed in such a way that the center line thereof coincides with a d axis d-axis. In addition, the hole portion 8 is disposed at an inner-circumferential position of the first portion 231 of the rotor core 23 forming a magnetic-field pole, i.e., between an inner-circumference peripheral portion 29a2 of the first magnet insertion hole 29a and an inner-circumference peripheral portion 29b2 of the second magnet insertion hole 29b.

The one side peripheral portion 8b1 of the weight-saving function portion 8b is connected with one end portion of the peripheral portion 8a1 of the positioning function portion 8a through the intermediary of one outer-circumference peripheral portion 8b4 that is parallel to the inner-circumference peripheral portion 8b3; the other side peripheral portion 8b2 of the weight-saving function portion 8b is connected with the other end portion of the peripheral portion 8a1 of the positioning function portion 8a through the intermediary of the other outer-circumference peripheral portion 8b5 that is parallel to the inner-circumference peripheral portion 8b3.

The one side peripheral portion 8b1 of the weight-saving function portion 8b faces the inner-circumference peripheral portion 29b2 of the second magnet insertion hole 29b via a predetermined space; the other side peripheral portion 8b2 of the weight-saving function portion 8b faces the inner-circumference peripheral portion 29a2 of the first magnet insertion hole 29a via a predetermined space. The predetermined space is set to be a minimum value that can suppress the effect on the flow of magnetic-field-pole flux and can maintain the strength required for the rotor core 23.

The other configurations of the electric rotating machine according to Embodiment 4 is the same as those of the electric rotating machine according to Embodiment 1.

In the electric rotating machine according to Embodiment 4, the mechanical loss in the bearing portions is reduced by the hole portion whose effect on the magnetic flux is small and that has a positioning function and a weight-saving function, so that the efficiency of the rotor can be raised.

### Embodiment 5

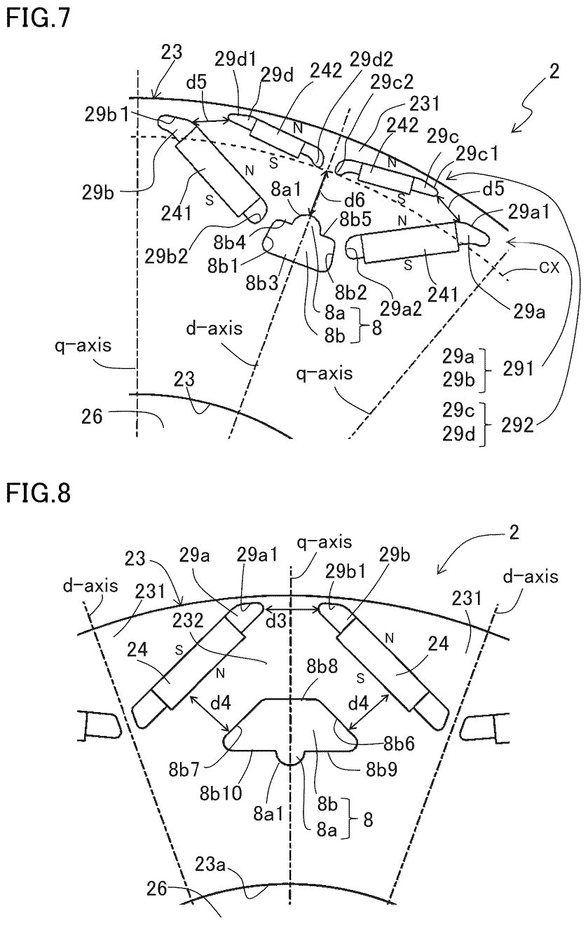

Next, an electric rotating machine according to Embodiment 5 will be explained. FIG. 7 is an explanatory view for the rotor of the electric rotating machine according to Embodiment 5. In an electric rotating machine according to Embodiment 5, a first magnet insertion hole step 291 and a second magnet insertion hole step 292 are arranged in a stepped manner in the first portion 231 of the rotor core 23 that forms one magnetic-field pole, in such a way as to be bilaterally symmetric with each other with respect to the d axis d-axis and in the radial direction from the inner circumferential side to the outer circumferential side of the rotor core 23. The first magnet insertion hole step 291 is provided at a more inner circumferential side than the second magnet insertion hole step 292 is.

The first magnet insertion hole step 291 includes the first magnet insertion hole 29a and the second magnet insertion hole 29b; the second magnet insertion hole step 292 includes a third magnet insertion hole 29c and a fourth magnet insertion hole 29d. A first permanent magnet 241 is inserted into each of the first magnet insertion hole 29a and the second magnet insertion hole 29b; a second permanent magnet 242 is inserted into each of the third magnet insertion hole 29c and the fourth magnet insertion hole 29d.

A hole portion 8 including a positioning function portion 8a and a weight-saving function portion 8b is disposed in such a way that the center line thereof coincides with a d axis d-axis. In addition, the hole portion 8 is provided at a portion of the rotor core 23, where the inner-circumference peripheral portion 29a2 of the first magnet insertion hole 29a and the inner-circumference peripheral portion 29b2 of the second magnet insertion hole 29b face each other.

The one side peripheral portion 8b1 of the weight-saving function portion 8b is connected with one end portion of the peripheral portion 8a1 of the positioning function portion 8a through the intermediary of one outer-circumference peripheral portion 8b4 that is parallel to the inner-circumference peripheral portion 8b3; the other side peripheral portion 8b2 of the weight-saving function portion 8b is connected with the other end portion of the peripheral portion 8a1 of the positioning function portion 8a through the intermediary of the other outer-circumference peripheral portion 8b5 that is parallel to the inner-circumference peripheral portion 8b3.

The one side peripheral portion 8b1 of the weight-saving function portion 8b faces the inner-circumference peripheral portion 29b2 of the second magnet insertion hole 29b via a predetermined space; the other side peripheral portion 8b2 of the weight-saving function portion 8b faces the inner-circumference peripheral portion 29a2 of the first magnet insertion hole 29a via a predetermined space. The predetermined space is set to be a minimum value that can suppress the effect on the flow of magnetic-field-pole flux and can maintain the strength required for the rotor core 23.

Each of the distance d5 [mm] between the outmost-circumference peripheral portion 29a1 of the first magnet insertion hole 29a and an outer-circumference peripheral portion 29c1 of the third magnet insertion hole 29c and the distance d5 [mm] between the outmost-circumference peripheral portion 29b1 of the second magnet insertion hole 29b and an outer-circumference peripheral portion 29d1 of the fourth magnet insertion hole 29d is the inter-magnet-insertion-hole-step shortest distance, which is the shortest distance between the first magnet insertion hole step 291 and the second magnet insertion hole step 292 in a magnet pole.

Letting CX denote a virtual circle that makes contact with an inner-circumference peripheral portion 29c2 of the third magnet insertion hole 29c and an inner-circumference peripheral portion 29d2 of the fourth magnet insertion hole 29d in the second magnet insertion hole step 292 provided at the outer circumferential side of the rotor core 23. The shortest distance d6 [mm] between the arc of the virtual circle CX and the peripheral portion 8a1 of the positioning function portion 8a of the hole portion 8 is set to be the same as or larger than the inter-magnet-insertion-hole-step shortest distance d5 (d6≥d5). Due to this configuration, in the first portion 231 of the rotor core 23, there exists no area, of the rotor core 23, that has a width narrower than the inter-magnet-insertion-hole-step shortest distance d5, so that the magnetic loss can be prevented from increasing.

In addition, in Embodiment 5 illustrated in FIG. 7, the number of the magnet insertion hole steps is two, i.e., the first magnet insertion hole step 291 and the second magnet insertion hole step 292; however, the number thereof may be three or more.

Moreover, it may be allowed that a hole portion including a positioning function portion and a weight-saving function portion is provided on the d axis d-axis of each of two or more magnet insertion hole steps. In this case, the configuration of the magnet insertion hole steps located at the outermost circumferential side of the rotor core 23 is the same as that of the magnet insertion hole and the hole portion according to Embodiment 4 illustrated in FIG. 6.

The other configurations of the electric rotating machine according to Embodiment 5 is the same as those of the electric rotating machine according to Embodiment 1. In this regard, however, the longitudinal cross-sectional view in FIG. 1 is not applied to Embodiment 5.

In the electric rotating machine according to foregoing Embodiment 5, the mechanical loss in the bearing portions is reduced by the hole portion whose effect on the magnetic flux is small and that has a positioning function and a weight-saving function, so that the efficiency of the rotor can be raised.

### Embodiment 6

Next, an electric rotating machine according to Embodiment 6 will be explained. FIG. 8 is an explanatory view for the rotor of the electric rotating machine according to Embodiment 6. In the electric rotating machine according to Embodiment 6, the positioning function portion 8a of the hole portion 8 is disposed at a more inner radial side of the rotor core 23 than the weight-saving function portion 8b is, and the positioning function portion 8a faces the fixing hole 23a of the rotor core 23.

The stress due to fitting between the rotor core 23 and the rotor shaft 26 and the stress due to the centrifugal force of the rotor 2 are generated at the rotor-core inner circumferential side of the hole portion; in the case where the result of a calculation indicates that these stresses each have a small value, the positioning function portion 8a can be disposed at the inner circumferential side of the rotor core 23.

The hole portion 8 including the positioning function portion 8a and the weight-saving function portion 8b is disposed in such a way that the center line thereof coincides with a q axis q-axis. This configuration makes it possible that the hole portion 8 is provided substantially in the middle portion of the two adjacent magnetic-field poles and that an imbalance in the magnetic flux flow between the two adjacent magnetic-field poles is prevented.

One side peripheral portion 8b6 of the weight-saving function portion 8b is connected with one end portion of the peripheral portion 8a1 of the positioning function portion 8a through the intermediary of one inner-circumference peripheral portion 8b9 that is parallel to an outer-circumference peripheral portion 8b8; the other side peripheral portion 8b7 of the weight-saving function portion 8b is connected with the other end portion of the peripheral portion 8a1 of the positioning function portion 8a through the intermediary of the other inner-circumference peripheral portion 8b10 that is parallel to the outer-circumference peripheral portion 8b8.

The one side peripheral portion 8b6 of the weight-saving function portion 8b extends in parallel with the long side of the permanent magnet 24 inserted into the second magnet insertion hole 29b; moreover, the other side peripheral portion 8b2 8b7 of the weight-saving function portion 8b extends in parallel with the long side of the permanent magnet 24 inserted into the first magnet insertion hole 29a. The shortest distance d4 [mm] between the magnet insertion hole and the hole portion, that is to say, each of the shortest distance d4 [mm] between the first magnet insertion hole 29a and the hole portion 8 and the shortest distance d4 [mm] between the second magnet insertion hole 29b and the hole portion 8 is configured to be the same as or larger than the shortest inter-magnetic-field-pole distance d3 [mm] (d4≥d3).

This configuration makes it possible to enlarge the occupation area of the hole portion 8, while suppressing the magnetic loss in the rotor 2.

The other configurations of the electric rotating machine according to Embodiment 6 is the same as those of the electric rotating machine according to Embodiment 1.

In the electric rotating machine according to Embodiment 6, the mechanical loss in the bearing portions is reduced by the hole portion whose effect on the magnetic flux is small and that has a positioning function and a weight-saving function, so that the efficiency of the rotor can be raised.

### Embodiment 7

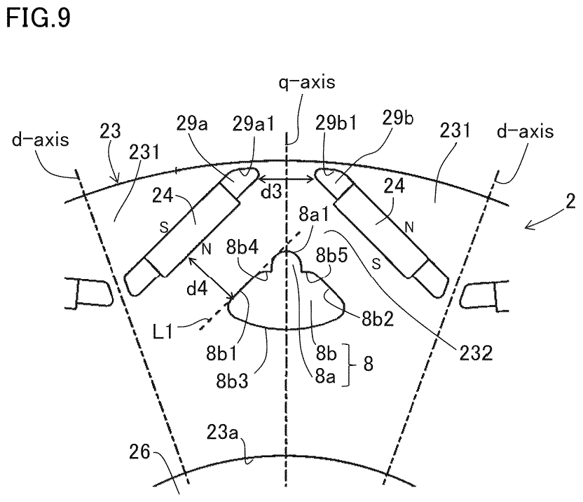

Next, an electric rotating machine according to Embodiment 7 will be explained. FIG. 9 is an explanatory view for the rotor of the electric rotating machine according to Embodiment 7. As illustrated in FIG. 9, in the electric rotating machine according to Embodiment 7, the inner-circumference peripheral portion 8b3 in the weight-saving function portion 8b of the hole portion 8 is configured to be in the shape of an arc that inflates toward the radially inside of the rotor core 23. The other configurations are the same as those of the electric rotating machine according to Embodiment 3 illustrated in FIG. 5.

The stress due to fitting between the rotor core 23 and the rotor shaft 26 and the stress due to the centrifugal force based on rotation of the rotor 2 are caused at the inner-circumference peripheral portion 8b3 in the weight-saving function portion 8b of the hole portion 8; however, in the electric rotating machine according to Embodiment 7, the inner-circumference peripheral portion 8b3 in the weight-saving function portion 8b is configured to be in the shape of an arc that inflates toward the radially inside of the rotor core 23, so that the foregoing stresses on the inner-circumference peripheral portion 8b3 formed in the shape of an arc are reduced.

In the electric rotating machine according to foregoing Embodiment 7, the mechanical loss in the bearing portions is reduced by the hole portion whose effect on the magnetic flux is small and that has a positioning function and a weight-saving function, so that the efficiency of the rotor can be raised.

### Embodiment 8

Next, an electric rotating machine according to Embodiment 8 will be explained. The electric rotating machine according to Embodiment 8 is configured in such a way that two or more rod-shaped positioning members (unillustrated) that each extend in the axial direction of the rotor core 23 are provided in at least one of the first end plate 25a abutting on the one axial-direction end portion of the rotor core 23 and the second end plate 25b abutting on the other axial-direction end portion of the rotor core 23 and in such a way that the each of the foregoing positioning member is inserted into the positioning function portion 8a of the hole portion 8 formed in the rotor core 23.

Each of the two or more rod-shaped positioning members provided in the end plate has a cross-sectional shape that coincides with the shape of the positioning function portion 8a in the hole portion 8 of the rotor core 23. In addition, the two or more rod-shaped positioning members are arranged apart from one another via a space that coincides with the space in the circumferential direction of the rotor core 23 between the adjacent positioning function portions 8a into which the respective corresponding rod-shaped positioning members are inserted.

In this situation, each of the two or more rod-shaped positioning members is preliminarily set to be inserted into which one of the positioning function portions 8a in the two-or-more hole portions 8 of the rotor core 23; the mutual space between the adjacent rod-shaped positioning members is set to coincide with the mutual space between the respective corresponding positioning function portions 8a into which the adjacent rod-shaped positioning members are to be inserted. In addition, the end plate may be configured in such a way that the mutual space between the adjacent rod-shaped positioning members can be adjusted in accordance with the mutual space between the respective corresponding positioning function portions 8a into which the adjacent rod-shaped positioning members are to be inserted.

The cross-sectional shape of each of the two or more rod-shaped positioning members provided in the end plate is formed so as to coincide with the cross-sectional shape of the corresponding positioning function portion 8a into which the rod-shaped positioning member is to be inserted. Moreover, the foregoing positioning member is set to be inserted into the positioning function portion 8a in the hole portion 8 of the rotor core 23 in the extent that a wobble falls within an allowable range.

Fitting between the rod-shaped positioning member in the end plate and the positioning function portion 8a in the hole portion 8 of the rotor core 23 makes it possible that the radial-direction two-dimensional location of the rotor 2 with respect to the stator 1 coincides with the center axis of the stator 1 and the rotor 2. In addition, in the case where the accuracy of fitting between the rod-shaped positioning member in the end plate and the positioning function portion 8a in the hole portion 8 of the rotor core 23 is within an allowable range, tolerable-degree rough positioning of the rotor 2 with respect to the stator 1 can be performed

### Embodiment 9

Next, an electric-rotating-machine manufacturing method according to Embodiment 9 will be explained. The electric-rotating-machine manufacturing method according to Embodiment 9 is an electric-rotating-machine manufacturing method in which the electric rotating machine according to any one of Embodiments 1 through 7 is manufactured in such a way that the respective positions of the center axes of the stator core and the rotor core are made to coincide with each other, by use of the positioning function portion in the hole portion of the rotor core 23 and a center-axis positioning jig.

The center-axis positioning jig has a rotor-core positioning portion for positioning the rotor core with respect to the stator core and stator-core holding portions for holding the stator core. The stator-core holding portions are arranged around the rotor-core positioning portions, and are each formed of, for example, a clamping mechanism and the like; the stator-core holding portions hold the stator core 13 at a predetermined position.

The rotor-core positioning portion includes two or more rod-shaped positioning members that are inserted into the respective positioning function portions 8a in the hole portions 8 provided in the rotor core 23, and holds the rotor core 23, so that radial-direction positioning of the rotor core 23 with respect to the stator core 13 is performed, by making the respective center axes of the stator core 13 and the rotor core 23 coincide with each other. The positioning jig is designed so as to be able to make the respective axes of the stator core and the rotor core coincide with each other with an error within a predetermined range.

Each of the two or more rod-shaped positioning members included in the rotor-core positioning portion has a cross-sectional shape that coincides with the shape of the positioning function portion 8a in the hole portion 8 of the rotor core 23. In addition, the two or more rod-shaped positioning members are arranged apart from one another via a space that coincides with the space in the circumferential direction of the rotor core 23 between the adjacent positioning function portions 8a into which the respective corresponding rod-shaped positioning members are inserted.

In this situation, each of the two or more rod-shaped positioning members is preliminarily set to be inserted into which one of the positioning function portions 8a in the two-or-more hole portions 8 of the rotor core 23; the mutual space between the adjacent rod-shaped positioning members is set to coincide with the mutual space between the respective corresponding positioning function portions 8a into which the adjacent rod-shaped positioning members are to be inserted. In addition, the rotor-core positioning portion may be configured in such a way that the mutual space between the adjacent rod-shaped positioning members can be adjusted in accordance with the mutual space between the respective corresponding positioning function portions 8a into which the adjacent rod-shaped positioning members are to be inserted.

The electric-rotating-machine manufacturing method according to Embodiment 9 is an electric-rotating-machine manufacturing method for manufacturing the electric rotating machine according to any one of Embodiments 1 through 7; the electric-rotating-machine manufacturing method includes
a stator-core holding process of holding the stator core by a stator holding portion of a center-axis positioning jig,
a rotor-core positioning process of positioning the rotor with respect to the stator, by inserting two or more rod-shaped positioning members in a rotor-core positioning portion of the center-axis positioning jig into respective positioning function portions of the hole portions in the rotor core, and
an assembling process of assembling at least part of the electric rotating machine after positioning of the rotor core with respect to the stator core has been performed in the rotor-core positioning process.

In addition, in view of preventing interference between the stator core 13 and the rotor core 23, it is advantageous that the stator-core holding process is performed earlier than the rotor-core positioning process is; however, when in particular, the interference between the stator core 13 and the rotor core 23 is not problematic, it may be allowed that any one of the stator-core holding process and the rotor-core positioning process is performed earlier than the other.

In the electric-rotating-machine manufacturing method according to Embodiment 9, by use of the positioning function portion of the hole portion in the rotor core and the center-axis positioning jig, there can be obtained an electric rotating machine that makes it possible to reduce the cost in manufacturing the electric rotating machine and to raise the efficiency of the electric rotating machine.

### Embodiment 10

Next, an electric-rotating-machine manufacturing method according to Embodiment 10 will be explained. The electric-rotating-machine manufacturing method according to Embodiment 10 is a method of manufacturing the electric rotating machine according to each of Embodiments 1 through 7; it relates to an electric-rotating-machine manufacturing method in which in the case where a hole portion having a positioning function portion the same as at least a positioning function portion of a hole portion provided in the rotor core is provided in at least one of a first end plate and a second end plate, an electric rotating machine is manufactured by use of the positioning function portion in the end plate and the positioning function portion in the rotor core.

The electric-rotating-machine manufacturing method according to Embodiment 10 is an electric-rotating-machine manufacturing method in which by inserting each of two or more rod-shaped positioning portions provided in the jig into both the positioning function portion of the hole portion provided in the end plate and the positioning function portion 8a of the hole portion 8 provided in the rotor core, the end plate is positioned with respect to the rotor core 23.

In the electric-rotating-machine manufacturing method according to Embodiment 10, by use of the positioning function portions of the hole portions in each of the end plate and the rotor core and the positioning jig, there can be obtained an electric rotating machine that makes it possible to reduce the cost in manufacturing the electric rotating machine and to raise the efficiency of the electric rotating machine.

### Embodiment 11

Next, an electric-rotating-machine manufacturing method according to Embodiment 11 will be explained. The electric-rotating-machine manufacturing method according to Embodiment 11 is a manufacturing method for the electric rotating machine according to foregoing Embodiment 8; positioning between the end plate and the rotor core is performed therein, by use of the positioning function portion in the hole portion of the rotor core and the end plate mounted on the axis-direction end portion of the rotor core.

The electric-rotating-machine manufacturing method according to Embodiment 11 is an electric-rotating-machine manufacturing method in which by inserting each of the two or more rod-shaped positioning members provided in the end plate into the positioning function portion 8a of the hole portion 8 provided in the rotor core 23, positioning between the end plate and the rotor core is performed.

In the electric-rotating-machine manufacturing method according to foregoing Embodiment 11, by use of the positioning function portion of the hole portion in the rotor core and the end plate having two or more columnar protrusions, there can be obtained an electric rotating machine that makes it possible to reduce the cost in manufacturing the electric rotating machine and to raise the efficiency of the electric rotating machine.

In addition, the positioning function portion of the hole portion in the electric rotating machine according to foregoing Embodiments 1 through 8 is provided, basically to be utilized for performing positioning between the respective center axes of the rotor and the stator or to be utilized for performing positioning between the rotor core and the end plate. However, for example, in view of communizing design of rotor members, it may be allowed that even in an electric rotating machine that is not manufactured based on any one of foregoing Embodiments 9 through 11, there is utilized the rotor core having the foregoing positioning function portion, as a commonized member between the electric rotating machine manufactured based on any one of foregoing Embodiments 9 through 11 and the electric rotating machine that is not manufactured based on any one of foregoing Embodiments 9 through 11.

Although the present disclosure is described above in terms of various exemplary embodiments, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present disclosure. For example, there are included the case where at least one constituent element is modified, added, or omitted and the case where at least one constituent element is extracted and then combined with constituent elements of other embodiments.

### DESCRIPTION OF REFERENCE NUMERALS

100: electric rotating machine
1: stator
12: frame
12a: flange
13: stator core
14: stator coil
2: rotor
23: rotor core
23a: fixing hole
231: first portion of rotor core
232: second portion of rotor core
24: permanent magnet
241: first permanent magnet
242: second permanent magnet
25a: first end plate
25b: second end plate
26: rotor shaft
27a: first bearing
27b: second bearing
28: stopper
29: magnet insertion hole pair
291: first magnet insertion hole step
292: second magnet insertion hole step
29a: first magnet insertion hole
29b: second magnet insertion hole
29c: third magnet insertion hole
29d: fourth magnet insertion hole
29a1, 29b1: outmost-circumference peripheral portion
29a2, 29b2: inner-circumference peripheral portion
8: hole portion
8a: positioning function portion
8a1: peripheral portion
8b: weight-saving function portion
8b1, 8b2, 8b6, 8b7: side peripheral portion
8b3, 8b9, 8b10: inner-circumference peripheral portion
8b4, 8b5, 8b5: outer-circumference peripheral portion

1. An electric rotating machine comprising:
a stator core formed in a ring-shaped manner;
a stator coil mounted on the stator core;
a rotor core whose outer circumferential portion faces an inner circumference portion of the stator core through an air gap and that has two or more magnet insertion holes;
two or more permanent magnets that are inserted into the respective two or more magnet insertion holes and form two or more magnetic-field poles in the rotor core;
a rotor shaft that penetrates a fixing hole provided in a radial-direction central portion of the rotor core and supports the rotor core; and
bearings that pivotably support the rotor shaft,
wherein the rotor core has a hole portion formed between the fixing hole and an outmost-circumference peripheral portion of the magnet insertion hole, and
wherein the hole portion includes
a positioning function portion that contributes to positioning of the rotor core, and
a weight-saving function portion that contributes to weight-saving of the rotor core.

2. The electric rotating machine according to claim 1,
wherein letting S1 and S2 denote an occupation area of the positioning function portion and an occupation area of the weight-saving function portion, respectively, the hole portion is formed in such a way that S2>S1 is established,
wherein the positioning function portion has an arc-shaped peripheral portion.

3. The electric rotating machine according to claim 1,
wherein the weight-saving function portion is configured in a triangular or trapezoidal shape whose circumferential width narrows toward the outer diameter side.

4. The electric rotating machine according to claim 2, wherein the arc-shaped peripheral portion of the positioning function portion is configured with an arc portion having an angle range of a mechanical angle the same as or larger than 180 [°].

5. The electric rotating machine according to claim 2, wherein letting d1 denote a diameter of the arc-shaped peripheral portion of the positioning function portion and letting d2 denote an maximum width of the weight-saving function portion in a circumferential-direction of the rotor core, the hole portion is formed in such a way that d2>d1 is established.

6. The electric rotating machine according to claim 5,
wherein the hole portion is disposed on a q axis of the magnetic-field pole, and
wherein letting d3 denote a shortest inter-magnetic-field-pole distance between adjacent magnetic-field poles and letting d4 denote a shortest distance between the magnet insertion hole and the hole portion, the rotor core is configured in such a way that d4≥d3 is established.

7. The electric rotating machine according to claim 6,
wherein the weight-saving function portion of the hole portion has a side peripheral portion extending in parallel with a long side of the permanent magnet, and
wherein the side peripheral portion of the weight-saving function portion is formed in such a way as to be superimposed on a virtual straight line L1 extending in parallel with the long side of the permanent magnet via the shortest distance d4.

8. The electric rotating machine according to claim 7,
wherein the positioning function portion of the hole portion has an arc-shaped peripheral portion, and the arc-shaped peripheral portion is formed in such a way as to make contact with the virtual straight line L1.

9. The electric rotating machine according to claim 1, wherein the hole portion is disposed on a d axis of the magnetic-field pole and is formed at a portion of the rotor core, where adjacent two magnet insertion holes in the magnetic-field pole face each other at a radially inside of the rotor core.

10. The electric rotating machine according to claim 9,
wherein the rotor core includes
a first magnet insertion hole step, and
a second magnet insertion hole step disposed at an outer circumferential side of the rotor core with respect to the first magnet insertion hole step,
wherein the first magnet insertion hole step is configured with a first magnet insertion hole and a second magnet insertion hole that are symmetrically arranged with respect to a virtual straight line extending in the radial direction of the rotor core,
wherein the second magnet insertion hole step is configured with a third magnet insertion hole and a fourth magnet insertion hole that are symmetrically arranged with respect to the virtual straight line,
wherein the two or more magnetic-field poles are formed with respective permanent magnets inserted into the first magnet insertion hole and the second magnet insertion hole and respective permanent magnets inserted into the third magnet insertion hole and the fourth magnet insertion hole, and
wherein the hole portion is formed between the fixing hole and an outmost-circumference peripheral portion at the third magnet insertion hole and the fourth magnet insertion hole.

11. The electric rotating machine according to claim 1, wherein the positioning function portion is disposed at more outer circumferential side of the rotor core than the weight-saving function portion is.

12. The electric rotating machine according to claim 2,
wherein the weight-saving function portion is disposed at more outer circumferential side of the rotor core than the positioning function portion is, and
wherein the arc-shaped peripheral portion of the positioning function portion is disposed in such a way as to face the fixing hole of the rotor core.

13. The electric rotating machine according to claim 1,
wherein at least one of axial-direction end portions of the rotor core is provided with an end plate that abuts on the rotor core in the axial direction, and
wherein the end plate is provided with a hole portion having a positioning function portion that coincides with at least the positioning function portion in the hole portion formed in the rotor core.

14. The electric rotating machine according to claim 1,
wherein at least one of axial-direction end portions of the rotor core is provided with an end plate that abuts on the rotor core in the axial direction, and
wherein the end plate has two or more rod-shaped positioning members that each extend in the axial direction of the rotor core, and
wherein the two or more positioning members are inserted into at least the respective positioning function portions in the two or more hole portions formed in the rotor core.

15. An electric-rotating-machine manufacturing method of manufacturing the electric rotating machine according to claim 1, the electric-rotating-machine manufacturing method comprising:
a stator-core holding process of holding the stator core by a stator-core holding portion of a center-axis positioning jig;
a rotor-core positioning process of positioning the rotor core with respect to the stator core, by inserting two or more rod-shaped positioning members in a rotor-core positioning portion of the center-axis positioning jig into respective positioning function portions of the hole portions in the rotor core; and
an assembling process of assembling at least part of the electric rotating machine after positioning of the rotor core with respect to the stator core has been performed in the rotor-core positioning process.

16. An electric-rotating-machine manufacturing method of manufacturing the electric rotating machine according to claim 13, the electric-rotating-machine manufacturing method comprising:
a stator-core holding process of holding the stator core by a stator-core holding portion of a center-axis positioning jig;
a rotor-core positioning process of positioning the rotor core with respect to the stator core, by inserting two or more rod-shaped positioning members in a rotor-core positioning portion of the center-axis positioning jig into the respective positioning function portions of the hole portions provided in the end plate and the respective positioning function portions of the hole portions provided in the rotor core; and
an assembling process of assembling at least part of the electric rotating machine after positioning of the rotor core with respect to the stator core has been performed in the rotor-core positioning process.

17. An electric-rotating-machine manufacturing method of manufacturing the electric rotating machine according to claim 13, wherein by inserting two or more rod-shaped positioning portions provided in a jig into both the respective positioning function portions of the hole portions provided in the end plate and the respective positioning function portions of the hole portions provided in the rotor core, positioning between the end plate and the rotor core is performed.

18. An electric-rotating-machine manufacturing method of manufacturing the electric rotating machine according to claim 14, wherein by inserting the two or more rod-shaped positioning members provided in the end plate into the respective positioning function portions of the hole portions provided in the rotor core, positioning between the end plate and the rotor core is performed.
